(19) United States
(12) Patent Application Publication
(10) Pub. No.: US 2017/0264165 A1
(43) Pub. Date: Sep. 14, 2017

(54) SYNCHRONOUS GENERATOR OF A GEARLESS WIND TURBINE

(71) Applicant: Wobben Properties GmbH, Aurich (DE)

(72) Inventors: Jochen RÖER, Ganderkesee (DE); Wojciech GIENGIEL, Aurich (DE)

(21) Appl. No.: 15/310,077

(22) PCT Filed: Apr. 23, 2015
(86) PCT No.: PCT/EP2015/058774

§ 371 Date: Nov. 9, 2016

(30) Foreign Application Priority Data
May 13, 2014 (DE) 10 2014 209 006.7

(51) Int. Cl. H02K 7/18; F03D 3/00; H02K 3/12; F03D 9/25; H02K 19/16; H02K 1/16

(52) U.S. Cl. CPC H02K 7/1838; H02K 19/16; H02K 1/16; H02K 3/12; F03D 9/25; F03D 3/002; H02K 2213/03

(57) ABSTRACT

A synchronous generator, in particular a multiple-pole synchronous ring generator of a gearless wind turbine, for generating electric current, comprising a rotor and a stator is provided. The stator has a large number of slots for receiving a stator winding in the form of conductor bundles, wherein the slots each have a slot base, whose surface is profiled in such a way that, during filling, a first layer on the slot base side of conductor bundles assumes an orientation which is preset by the profile. A stator for such a generator and to a wind turbine comprising such a generator is provided.

### BACKGROUND

Technical Field

The present invention relates to a synchronous generator, in particular a multiple-pole synchronous ring generator of a gearless wind turbine. In addition, the present invention relates to a generator stator for such a synchronous generator and to a wind turbine comprising such a synchronous generator.

Description of the Related Art

In the German application giving grounds for priority, the German Patent and Trademark Office has searched the following documents: DE 10 2011 078 025 A1, US 2005/0 029 889 A1, AT 513 114 A1, DE 20 1011 078 025 A1 and US 2005/0 218 744 A1.

Wind turbines are generally known. They generate electric current from wind by means of a generator. Modern gearless wind turbines often have a multiple-pole synchronous ring generator having a large air-gap diameter. The diameter of the air gap is in this case at least four meters and is usually up to almost five meters. Synchronous generators assembled from a plurality of parts can quite easily have air-gap diameters in the range of ten meters or more.

The efficiency of the synchronous generator critically influences the efficiency of the wind turbine overall for electricity generation. In order to achieve an efficiency for electricity generation which is as high as possible, it is therefore important for the stator winding to have an optimum configuration. This also in particular includes accommodating, where possible, a high number of conductor bundles in the stator winding. Since the production of the stator winding often takes place manually by means of filling the slots provided in the stator, however, in order to ensure the required quality and safety of the generator, there are sometimes fluctuations in respect of the filling of the respective slots and non-optimum utilization of the filling area available in the slots.

### BRIEF SUMMARY

Embodiments are directed to a synchronous generator of the type mentioned at the outset. In particular, the synchronous generator, in particular a multiple-pole synchronous ring generator of a gearless wind turbine, for generating electric current, comprises a rotor and a stator, wherein the stator has a large number of slots for receiving a stator winding in the form of conductor bundles, wherein the slots each have a slot base, whose surface is profiled in such a way that, during filling, a first layer on the slot base side of conductor bundles assumes an orientation which is preset by the profile.

“Multiple-pole” in the case of a synchronous ring generator of a gearless wind turbine is understood to mean a multiplicity of stator poles, in particular a formation with at least 48 stator teeth, often even with considerably more stator teeth, such as in particular 96 stator teeth or even more stator teeth. The magnetically active region of the generator, namely both of the rotor, which can also be referred to as armature, and of the stator, is arranged in a ring-shaped region around the axis of rotation of the synchronous generator. Thus, in particular a range of from 0 to at least 50% of the radius of the air gap is free of materials which conduct electric current or electrical field of the synchronous generator. In particular, this interior is completely free and can in principle also be traversed. Often, this region is even more than 0 to 50% of the air-gap radius, in particular up to 0 to 70% or even 0 to 80% of the air-gap radius. Depending on the design, a supporting structure can be provided in this inner region, which supporting structure can in some embodiments be axially offset, however. Depending on the function, such synchronous generators of a gearless wind turbine are slowly rotating generators. Slowly rotating is in this case understood to mean a rotation speed of below 40 revolutions per minute, in particular of approximately 4 to 35 revolutions per minute, depending on the size of the installation.

In adequate utilization of space within a slot in the stator arises when the lowermost layers in the slot, i.e., the layers closest to the slot base, of conductor bundles are laid unevenly. This results in a nonuniform distribution of the conductor bundles above this layer as well and therefore necessarily in the formation of unused interspaces. This is where the invention comes in by virtue of a start profile for the filling with conductor bundles being preset at the slot base by means of profiling. Owing to the profiling of the slot base, the conductor bundles filled into the slot first are laid in a predetermined orientation. In accordance with the invention, this first layer then to a certain extent forms, by means of the already pre-oriented conductor bundles, a follow-on profile for the second layer of conductor bundles to be introduced into the slot. This in turn forms the next follow-on profile for the layer of conductor bundles to be arranged thereabove, and so on. Even by virtue of the definition of an approximate position of the first layer on the slot base, in this way the entire structure of the conductor bundles in the slot becomes more uniform. Already owing to this uniformity, there is less pronounced a formation of unused interspaces, as a result of which the fill factor, also referred to as the packing density, within the slot increases. In this case, it is not a question of positioning the layer of conductor bundles on the slot base side precisely. Owing to the conductor bundles introduced next, the respective conductor bundles positioned therebeneath are automatically pressed into a uniform spacing with respect to one another and assume a corresponding position between the already laid conductor bundles. Thus, it is only critical that the number of conductor bundles positioned at the slot base is determined by the profile of the slot base area, and that said conductor bundles are kept at a spacing from one another. See in this regard in particular the advantageous developments explained below.

In accordance with a first advantageous embodiment, the profile has one or more projections, which protrude from the slot base, and/or one or more cutouts, which are recessed into the slot base.

Preferably, the profile is designed to position the conductor bundles on the slot base side at a spacing A from one another, which spacing is selected such that the maximum number of conductor bundles which can be arranged in the first layer is reduced in comparison with an unprofiled slot base. It may initially appear to be counterproductive not to pack as many conductor bundles as possible into the lowermost layer on the slot base side. In fact, it has been found that it is precisely also such a limitation which advantageously results in a uniform formation of the conductor bundle structure in the slot. In a preferred embodiment, a spacing A′ between adjacent projections or between adjacent cutouts is substantially equal to the spacing A between the respectively adjacent conductor bundles within a layer of conductor bundles.

Within the context of the invention, the term spacing is understood to mean the center spacing, i.e., the spacing from center to center of a respective conductor bundle or from center to center of a respective projection or a respective cutout.

In a further preferred embodiment, the spacing A′ between adjacent projections and/or adjacent cutouts is selected depending on the diameter d of the conductor bundles such that each conductor bundle of a second layer which is stacked onto the first layer rests on two adjacent conductor bundles from the first layer therebeneath.

Preferably, the spacing A′ or A is in a range of from 1.5 times to 1.85 times the conductor bundle diameter d.

Particularly preferably, the spacing A or A′ is in a range of from 1.7 times to 1.75 times the conductor bundle diameter d. Particularly preferably, the spacing A or A′ is \sqrt{3} times the conductor bundle diameter d. In a further preferred embodiment, the slots each extend inwards from a circumferential surface of the stator and each have a constant slot width B. Therefore, said slots in particular have two parallel slot walls, which extend from the circumferential surface towards the slot base.

In a further preferred configuration, the slot width B results from the equation B=d(1+n·C), where d is the conductor bundle diameter, n is a positive natural number, and C is a coefficient in the range of from 0.85 to 0.95. In other words, the slot width B results as the sum of the conductor bundle diameter and a product of the conductor bundle diameter d and the coefficient C, or is an integral positive multiple of this product. In particular, “n” is lower, by one, than the number of conductor bundles which can be arranged in the two adjacent layers, for example the first layer closest to the slot base and the second layer following said first layer. When n=7, a slot width B results, for example, in which in each case four conductor bundles are arranged in adjacent layers. When n=8, a width results in which alternately five conductor bundles can be introduced into the slot in one layer, and four conductor bundles in the adjacent layer. There is a corresponding behavior for other even and uneven numbers for n.

In a preferred embodiment. C is in the range of from 0.86 to 0.87. Particularly preferably,

$$C = \frac{\sqrt{3}}{2} .$$

In a further preferred embodiment, the projections of the profile have a height h above the slot base which is in each case at most half the conductor bundle diameter D. Alternatively or in addition, the cutouts in the profile have a depth into the slot base which is at most in each case half the conductor bundle diameter d. By limiting the height or depth of the profile relative to the slot base, conductor bundles in the second layer, which are laid on top of the layer of conductor bundles on the slot base side, are prevented from coming to bear, in an undesired manner, exclusively on the projections or the regions between two adjacent cutouts, but said conductor bundles are not prevented from coming to bear with the adjacent conductor bundles, as a result of which, in turn, a certain risk of a nonuniform formation is avoided.

In a preferred embodiment, the projections and/or cutouts have side faces which are beveled towards the slot base. This facilitates the filling of the slot with the first layer of conductor bundles on the slot base side. The inserted conductor bundles can slide along the slopes towards the slot base and in this way are brought more quickly into the position intended for them.

A large number of features of the synchronous generator is embodied in the stator of this synchronous generator. In accordance with a further aspect, a stator of a synchronous generator is therefore proposed, in particular a multiple-pole synchronous ring generator of a gearless wind turbine, wherein the stator has a large number of slots for receiving a stator winding in the form of conductor bundles, wherein the slots each have a slot base, whose surface is profiled in such a way that, during filling, a first layer on the slot base side of conductor bundles assumes an orientation which is preset by the profile. In this way, the above-described stator also achieves the object in respect of the synchronous generator in the same way. As regards the advantages and basic knowledge in respect of this aspect according to the invention, reference is made to the details set forth above relating to the synchronous generator according to the invention.

The stator according to the invention is preferably developed in the same way as the synchronous generator according to the invention, with the result that reference is made to the preferred embodiments of the synchronous generator described above in respect of preferred embodiments of the stator.

The invention also relates to a wind turbine, in particular a gearless wind turbine, comprising a synchronous generator. In accordance with the invention, it is proposed that the synchronous generator is designed in accordance with one of the above-described preferred embodiments.

### BRIEF DESCRIPTION OF THE SEVERAL VIEWS OF THE DRAWINGS

The invention will be explained in more detail below on the basis of preferred exemplary embodiments with reference to the attached figures, in which:

FIG. 1 shows a wind turbine schematically in a perspective view,

FIG. 2 shows a nacelle of the wind turbine shown in FIG. 1 schematically in a perspective sectional view,

FIG. 3 shows, in simplified form, a schematic perspective view of a stator of the wind turbine shown in FIGS. 1 and 2,

FIG. 4a shows a schematic cross-sectional view of a slot in a stator in accordance with the prior art, and

FIG. 4b shows a schematic cross-sectional view of a slot in a stator according to the invention of a synchronous generator according to the invention.

### DETAILED DESCRIPTION

Identical reference symbols can be used below to identify similar but not identical elements. In addition, the same elements can be represented on a different scale.

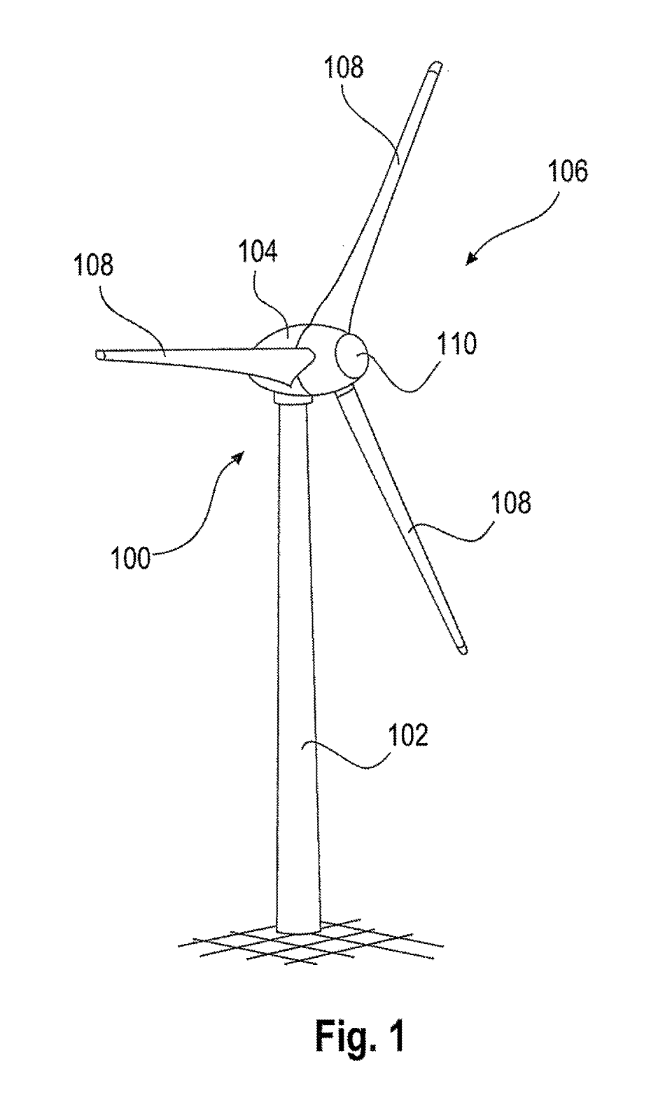

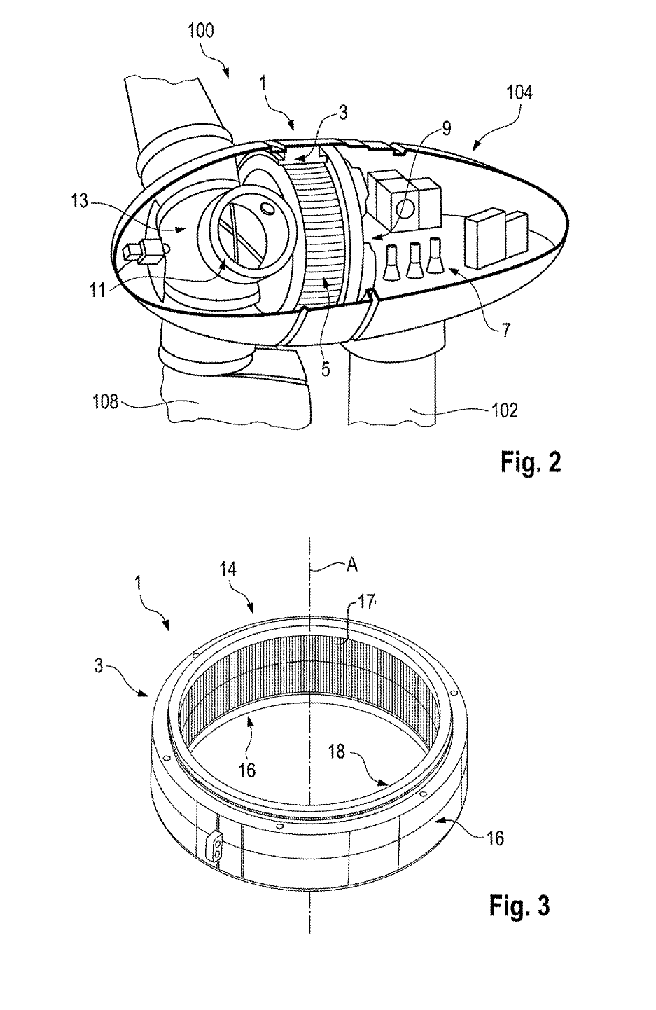

FIG. 1 shows a wind turbine 100 comprising a tower 102 and a nacelle 104. A rotor 106 having three rotor blades 108 and a spinner 110 is arranged on the nacelle 104. The rotor 106 is set in rotary motion by the wind during operation and thus drives a generator 1 (FIG. 2) in the nacelle 104.

The nacelle 104 is shown in FIG. 2. The nacelle 104 is mounted rotatably on the tower 102 and is connected so as to be driven in a generally known manner by means of an azimuthal drive 7. In a further generally known manner, a machine mount 9, which holds a synchronous generator 1, is arranged in the nacelle 104. The synchronous generator 1 is designed in accordance with the present invention and is in particular a slowly rotating, multiple-pole synchronous ring generator. The synchronous generator 1 has a stator 3 and an internally rotating rotor 5, also referred to as an armature. The rotor or armature 5 is connected to a rotor hub 13, which transfers the rotational movement of the rotor blades 108 caused by the wind to the synchronous generator 1.

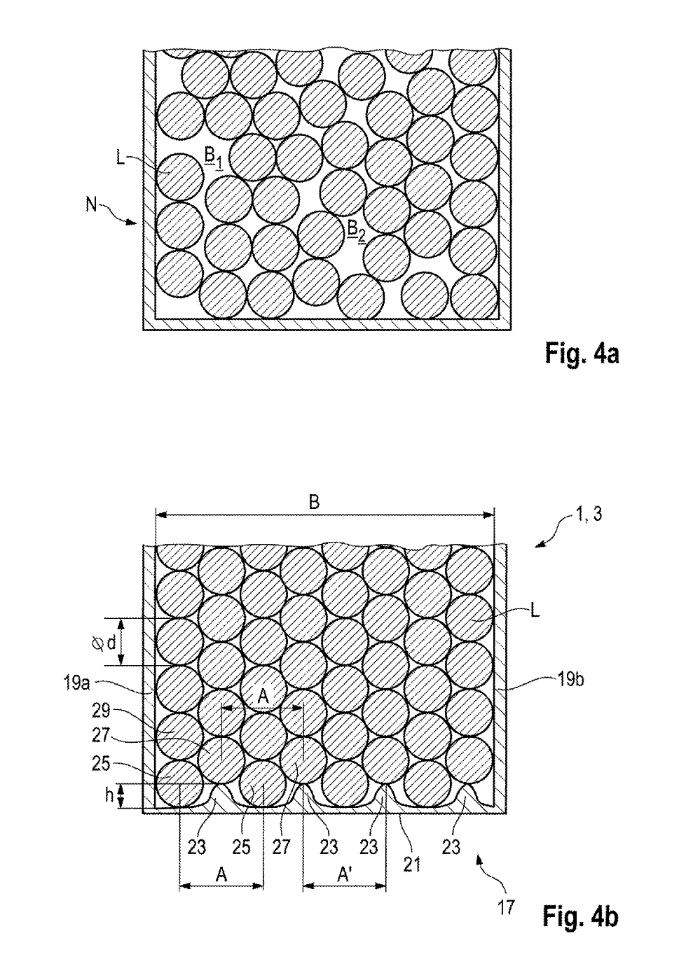

FIG. 3 shows the stator 3 on its own. The stator 3 has a stator ring 16 having an inner circumferential surface 18. The inner circumferential surface is delimited by a first end face 14 and a second end face 16, which is opposite the first end face 14. A large number of slots 17 is provided in the inner circumferential surface 18, said slots being designed to receive the stator winding in the form of conductor bundles 25, 27, 29 (FIG. 4b). The structural design of the slots 17 is shown in FIG. 4b. The slots 17 extend between the first end face 14 and the second end face 16 and are aligned parallel to a longitudinal axis A. The longitudinal axis A is the axis of rotation of the rotor 5 in the generator 1.

The configuration of the slots 17 will be explained below in particular also with comparable consideration with respect to a non-profiled slot N which is not in accordance with the invention, as shown in FIG. 4a. In the case of the slot N shown in FIG. 4a, it can clearly be seen that a large number of conductor bundles L is introduced into the slot N with a substantially unordered arrangement. This results in regions with a low packing density, for example regions B₁ and B₂. Overall, therefore, only suboptimal filling takes place in the case of the slot N shown in FIG. 4a.

In contrast to this, FIG. 4b shows a slot 17 in a stator 3 according to an embodiment of the invention or synchronous generator 1. The slot 17 has a slot width B. The slot is laterally delimited by two parallel side walls 19a, b, which extend from the circumferential surface 18 (FIG. 3) towards a slot base 21. A plurality of, in this case four, for example, inwardly projecting projections 23 are formed on the surface of the slot base 21, which projections each have a height h with respect to the slot base 21. The projections 23 are arranged in each case at a spacing of A′ with respect to one another. Owing to the arrangement of the projections 23, a first layer 25 of conductor bundles L on the slot base side is arranged right at the bottom in the slot 17. The conductor bundles in the first layer 25 are arranged in each case at a spacing A with respect to one another, determined by the projections 23. Preferably, the spacing A corresponds to the spacing A′ of the projections with respect to one another, wherein in this case in each case the spacings of the center points with respect to one another are considered.

Owing to the orientation of the conductor bundles L in the first layer 25 which is preset by the projections 23, as filling is continued, conductor bundles L in a second layer 27 are in each case inserted into the slot in such a way that they are arranged in the gaps or “valleys” between two adjacent conductor bundles L in the first layer 25. Uniform spacing of the projections 23 with respect to one another therefore results also in uniform spacing of the conductor bundles L in the second layer 27 as well as in uniform spacing of the conductor bundles L in the first layer 25. This is continued successively for a third layer 29 of conductor bundles and further layers. The conductor bundles all have the same diameter d.

In the exemplary embodiment shown, the height h is less than or equal to half the conductor bundle diameter d. The spacing A between two adjacent conductor bundles is in a range of from 1.5 times to 1.85 times the conductor bundle diameter d.

As can be seen directly from FIG. 4b, the center points of all of the conductor bundles in the cross-sectional view shown slot into a uniform lattice so that each conductor bundle, with the exception of the conductor bundles arranged at the rims of the slot 17—side walls 19a, b and slot base 21 —, has six nearest neighbors, wherein ideally in each case three most closely adjacent conductor bundles span an equilateral triangle with one another. As a result, a filling or packing density which is optimized in comparison with the illustration shown in FIG. 4a is achieved. Particularly preferably, the projections 23 are formed from the same material as the conductor bundles L, as a result of which the space taken up by the projections 23 can still also be used.

Each conductor bundle in the second layer 27 and in each following layer 29 preferably rests on in each case conductor bundles lying therebeneath at two points of contact. The conductor bundles L in the second layer 27 can in the individual case also come into contact with the projections 23, wherein the formation of an irregularity is restricted, however, owing to the restricted height h of the projections 23.

The width B of the slot 17 shown in FIG. 4b in the present case is d(1+7C), where C is in the range of from 0.85 to 0.95.

1. A synchronous generator, of a wind turbine for generating electric current, the synchronous generator comprising:
a rotor and a stator, wherein the stator has a plurality of slots for receiving a stator winding in the form of conductor bundles,
wherein each of the plurality of slots has a slot base having a surface that is profiled in such a way that, during filling, a first layer on the slot base side of conductor bundles assumes an orientation that is preset by the profile.

2. The synchronous generator according to claim 1,
wherein the profile has one or more projections that protrude from the slot base.

3. The synchronous generator according to claim 2,
wherein the profile is designed to position the conductor bundles on the slot base side at a spacing from one another, wherein the spacing is selected such that a maximum number of conductor bundles that is configured to be arranged in the first layer is reduced in comparison with a slot not having a surface that is profiled.

4. The synchronous generator according to claim 3,
wherein the one or more projection are a plurality of projections, wherein a spacing between in each adjacent projections is substantially equal to the spacing between the adjacent conductor bundles.

5. The synchronous generator according to claim 3,
wherein the one or more projection are a plurality of projections wherein the spacing between adjacent projections is selected depending on a diameter of the conductor bundles such that each conductor bundle of a second layer that is stacked onto the first layer rests on two adjacent conductor bundles from the first layer therebeneath.

6. The synchronous generator according to claim 5,
wherein the spacing is in a range of from 1.5 to 1.85 times a diameter of the conductor bundle.

7. The synchronous generator according to claim 5,
wherein the spacing is in a range of from 1.7 to 1.75 times a diameter of the conductor bundle.

8. The synchronous generator according to claim 5,
wherein the spacing is \sqrt{3} times a diameter of the conductor bundle.

9. The synchronous generator according to claim 1,
wherein the plurality of slots each extend inwards from a circumferential surface of the stator and each have a slot width.

10. The synchronous generator according to claim 9,
wherein the slot width results, sectionally or completely, from the equation
B=d(1+n·C),
wherein:
d is the conductor bundle diameter,
n is a positive natural number, and
C is a coefficient in the range of from 0.85 to 0.95.

11. The synchronous generator according to claim 10,
wherein C is in a range of from 0.86 to 0.87.

12. The synchronous generator according to claim 10,
wherein
$$C = \frac{\sqrt{3}}{2} .$$

13. The synchronous generator according to claim 2,
wherein the one or more projections have a height above the slot base that is at most half a height of the conductor bundle diameter.

14. The synchronous generator according to claim 2,
wherein the one or more projections have side faces that are beveled towards the slot base.

15. A stator of a synchronous generator, the stator comprising:
a plurality of slots for receiving a stator winding in the form of conductor bundles,
wherein each of the plurality of slots have a slot base including a surface that is profiled in such a way that, during filling, a first layer on the slot base side of conductor bundles assumes an orientation that is preset by the profile.

16. A wind turbine, comprising a synchronous generator according to claim 1.

17. The synchronous generator according to claim 1,
wherein the profile has one or more recesses spaced apart from each other.

18. The synchronous generator according to claim 17,
wherein the one or more recesses have a depth in the slot base that is less than a height of the conductor bundle diameter.

19. The synchronous generator according to claim 17,
wherein the one or more recesses are a plurality of recesses, wherein a spacing between in each adjacent recess is substantially equal to the spacing between the adjacent conductor bundles.
